(19) United States
(12) Patent Application Publication
(10) Pub. No.: US 2015/0268519 A1
(43) Pub. Date: Sep. 24, 2015

(54) LIQUID CRYSTAL DISPLAY

(71) Applicant: SAMSUNG DISPLAY CO., LTD., Yongin-City (KR)

(72) Inventors: Eun-Kil Park, Cheonan-si (KR); Young Goo Song, Asan-si (KR); Hyung Gi Jung, Cheonan-si (KR)

(21) Appl. No.: 14/641,266

(22) Filed: Mar. 6, 2015

(30) Foreign Application Priority Data
Mar. 21, 2014 (KR) 10-2014-0033643

(51) Int. Cl. G02F 1/1343; G02F 1/1333

(52) U.S. Cl. CPC G02F 1/134309; G02F 1/133345; G02F 1/13439; G02F 2001/134345

(57) ABSTRACT

A liquid crystal display includes a first substrate, a first subpixel electrode on the first substrate configured to receive a first voltage and including a first and second subregion, a second subpixel electrode on the first substrate configured to receive a second voltage and including a third subregion and a fourth subregion, an insulating layer between the first subpixel electrode and the second subpixel electrode, a second substrate facing the first substrate, and a common electrode at the second substrate and configured to receive a common voltage, wherein the third subregion overlaps the first subregion, the second subregion includes first branch electrodes, the second subpixel electrode includes second branch electrodes, the first branch electrodes and the second branch electrodes include a first end and a second end facing each other, and the second branch electrodes have a reduced width at the second end.

### CROSS-REFERENCE TO RELATED APPLICATION

This application claims priority to and the benefit of Korean Patent Application No. 10-2014-0033643, filed in the Korean Intellectual Property Office on Mar. 21, 2014, the entire content of which is incorporated herein by reference.

### BACKGROUND

1. Field

Aspects of one or more embodiments of the present invention relate to a liquid crystal display.

2. Description of the Related Art

A liquid crystal display, as one of flat panel display devices that are widely used, includes two display panels where field generating electrodes, such as a pixel electrode or a common electrode, are formed, and a liquid crystal layer interposed therebetween.

The liquid crystal display generates an electric field in the liquid crystal layer by applying voltages to the field generating electrodes, to determine orientations of liquid crystal molecules of the liquid crystal layer and control polarization of incident light, thereby displaying an image.

The liquid crystal display also includes a plurality of thin film transistors connected to the pixel electrodes, and a plurality of signal lines such as gate lines and data lines for controlling them by applying a voltage to the pixel electrodes.

Among the liquid crystal displays, a vertical alignment (VA) mode liquid crystal display, which aligns LC molecules such that the long axes of the LC molecules are substantially perpendicular to the panels in the absence of an electric field, is spotlighted because of its high contrast ratio and wide reference viewing angle. A reference viewing angle is defined as a viewing angle that makes the contrast ratio equal to 1:10 or as a limit angle for inversion in luminance between gray levels.

The VA mode liquid crystal displays divide one pixel into two subpixels and apply different voltages to the subpixels so that transmittance is changed and side visibility is improved to be close to front visibility.

However, when dividing one pixel into two subpixels and approximating the side visibility to the front visibility by differentiating the transmittance, the luminance is increased at a low gray level or high gray level such that gray level expression is difficult at the side, thereby deteriorating display quality.

Also, when dividing one pixel into a plurality of regions, an irregular movement of the liquid crystal molecules is generated in the boundary portion of the region such that display quality deterioration, such as a transmittance reduction, may be generated.

The above information disclosed in this Background section is only for enhancement of understanding of the background of the invention and therefore it may contain information that does not form the prior art that is already known in this country to a person of ordinary skill in the art.

### SUMMARY

Aspects of embodiments of the present invention are directed toward a liquid crystal display capable of expressing an accurate gray level in a low gray region while side visibility is close to (matched to) front visibility, and reducing (e.g., preventing) display quality deterioration.

A liquid crystal display, according to an example embodiment of the present invention, includes: a first substrate; a first subpixel electrode on the first substrate and including a first subregion and a second subregion, the first subpixel electrode being configured to receive a first voltage; a second subpixel electrode on the first substrate and including a third subregion and a fourth subregion, the second subpixel electrode being configured to receive a second voltage; an insulating layer between the first subpixel electrode and the second subpixel electrode; a second substrate facing the first substrate; and a common electrode at the second substrate and configured to receive a common voltage, wherein the third subregion overlaps the first subregion, wherein the second subregion comprises a plurality of first branch electrodes, wherein the second subpixel electrode comprises a plurality of second branch electrodes, wherein the plurality of first branch electrodes and the plurality of second branch electrodes comprise a first end and a second end facing each other, and wherein the plurality of second branch electrodes have a reduced width at the second end.

In an embodiment, the plurality of first branch electrodes have a reduced width at the first end.

In an embodiment, the first end and the second end overlap the first subregion.

In an embodiment, a difference of a great width of the plurality of first branch electrodes and a reduced width of the first end is more than about 0.4 μm, and a difference of a great width of the plurality of second branch electrodes and a reduced width of the second end is more than about 0.4 μm.

In an embodiment, the first subregion and the second subregion are coupled through a contact opening formed at the insulating layer.

In an embodiment, a difference of the first voltage and the common voltage is greater than a difference of the second voltage and the common voltage.

In an embodiment, a width of the plurality of first branch electrodes is gradually decreased closer to the first end, and a width of the plurality of second branch electrodes is decreased closer to the second end.

In an embodiment, a ratio of the reduced width of the first end to the great width of the plurality of first branch electrodes is less than about 0.86, and a ratio of the reduced width of the second end to the great width of the plurality of second branch electrodes is less than about 0.86.

In an embodiment, the first subregion and the second subregion are coupled through a contact opening at the insulating layer.

In an embodiment, a difference of the first voltage and the common voltage is greater than a difference of the second voltage and the common voltage.

In an embodiment, the second end overlaps the first subregion.

In an embodiment, a difference of a great width of the plurality of second branch electrodes and the reduced width of the second end is more than about 0.4 μm.

In an embodiment, the first subregion and the second subregion are coupled through a contact opening formed at the insulating layer.

In an embodiment, a difference of the first voltage and the common voltage is greater than a difference of the second voltage and the common voltage.

In an embodiment, a width of a plurality of second branch electrodes is gradually decreased closer to the second end.

In an embodiment, a ratio of the reduced width of the second end to the great width of a plurality of second branch electrode is less than about 0.86.

In an embodiment, the first subregion and the second subregion are coupled through a contact opening formed at the insulating layer.

In an embodiment, a difference of the first voltage and the common voltage is greater than a difference of the second voltage and the common voltage.

According to an example embodiment of the present invention, an accurate gray level may be expressed in a low gray region while side visibility is close to (is matched to) front visibility, and display quality deterioration may be reduced (e.g., prevented).

### BRIEF DESCRIPTION OF THE DRAWINGS

FIG. 1 is a layout view of a liquid crystal display, according to an example embodiment of the present invention.

FIG. 2 is a cross-sectional view of the liquid crystal display of FIG. 1 taken along the line II-II.

FIG. 3 is a layout view of a first portion of a first subpixel electrode of the liquid crystal display of FIG. 1.

FIG. 4 is a layout view of a second portion of a first subpixel electrode of the liquid crystal display of FIG. 1 and a second subpixel electrode.

FIG. 5 is a view of a portion of the liquid crystal display of FIG. 1.

FIG. 6 is a cross-sectional view of the liquid crystal display of FIG. 1 taken along the line VI-VI.

FIG. 7 is a cross-sectional view of the liquid crystal display of FIG. 1 taken along the line VII-VII.

FIG. 8 is a cross-sectional view of the liquid crystal display of FIG. 1 taken along the line VIII-VIII.

FIG. 9 is a layout view of a liquid crystal display, according to another example embodiment of the present invention.

FIG. 10 is a layout view of a first portion of a first subpixel electrode of the liquid crystal display of FIG. 9.

FIG. 11 is a layout view of a second portion of a first subpixel electrode of the liquid crystal display of FIG. 9 and a second subpixel electrode.

FIG. 12 is a view of a portion of the liquid crystal display of FIG. 9.

FIG. 13 is an electron microscopic picture of a transmittance result of a liquid crystal display, according to an experimental example of the present invention.

FIG. 14 is an electron microscopic picture of a transmittance result of a liquid crystal display, according to another experimental example of the present invention.

### DETAILED DESCRIPTION

Example embodiments of the present invention will be described in more detail with reference to the attached drawings. The present invention may be modified in many different forms, and should not be construed as being limited to the example embodiments set forth herein. Rather, the example embodiments of the present invention are provided so that this disclosure will be thorough and complete, and will fully convey the concept of the present invention to those skilled in the art.

In the drawings, the thickness of layers and regions may be exaggerated for clarity. In addition, when a layer is described to be formed on another layer or on a substrate, this means that the layer may be formed on the other layer or on the substrate, or a third layer may be interposed between the layer and the other layer or the substrate. Like numbers refer to like elements throughout the specification.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Further, the use of “may” when describing embodiments of the inventive concept refers to “one or more embodiments of the inventive concept.” Also, the term “exemplary” is intended to refer to an example or illustration. It will be understood that when an element or layer is referred to as being “on”, “connected to”, “coupled to”, or “adjacent to” another element or layer, it can be directly on, connected to, coupled to, or adjacent to the other element or layer, or one or more intervening elements or layers may be present. As used herein, the term “substantially,” “about,” and similar terms are used as terms of approximation and not as terms of degree, and are intended to account for the inherent deviations in measured or calculated values that would be recognized by those of ordinary skill in the art.

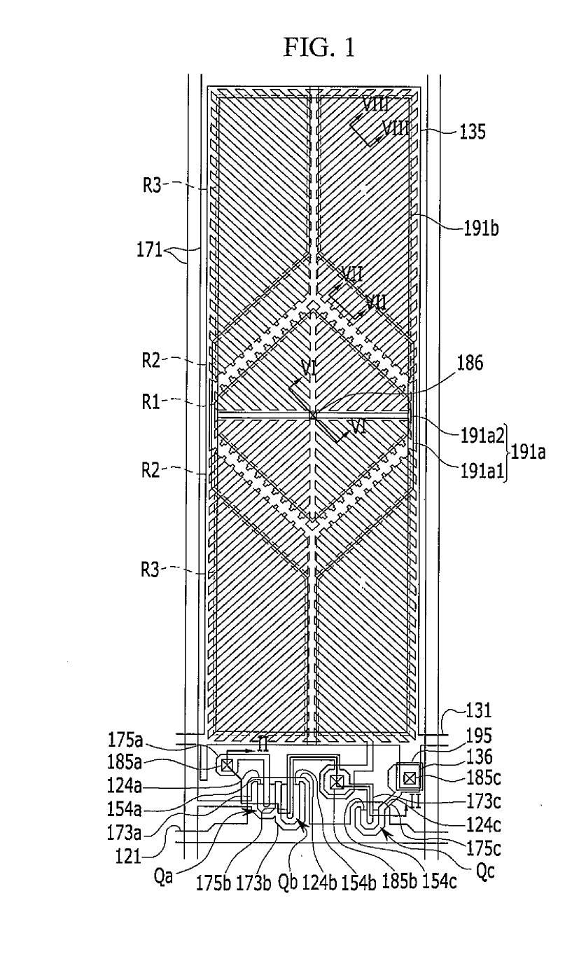

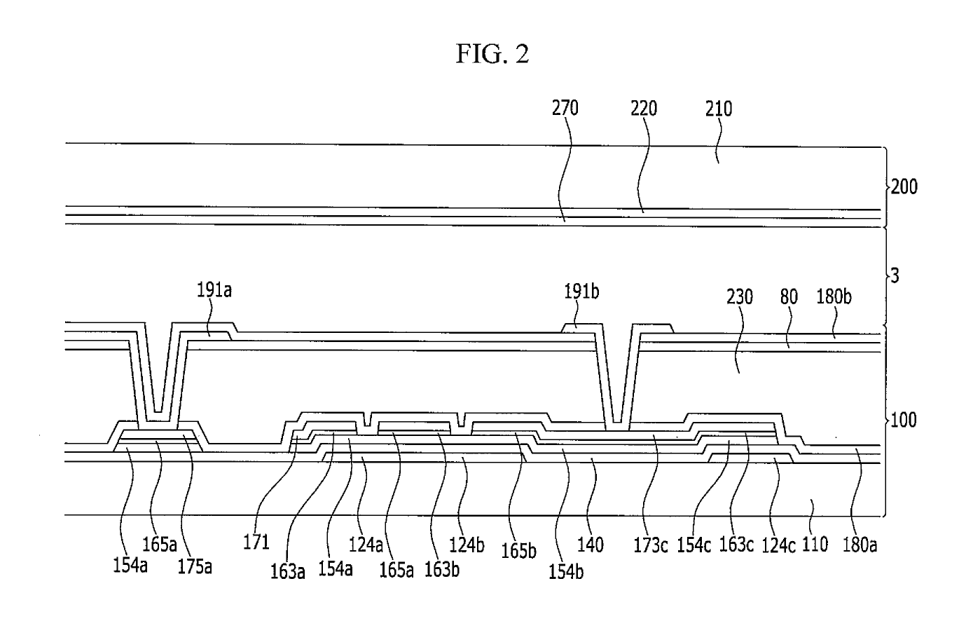

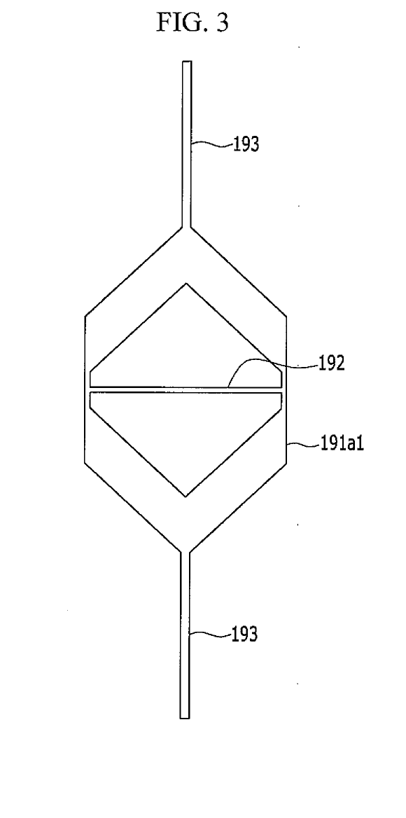

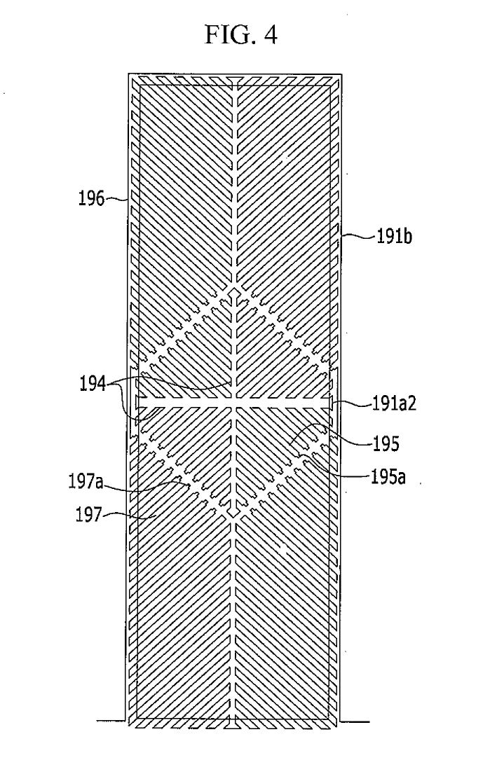

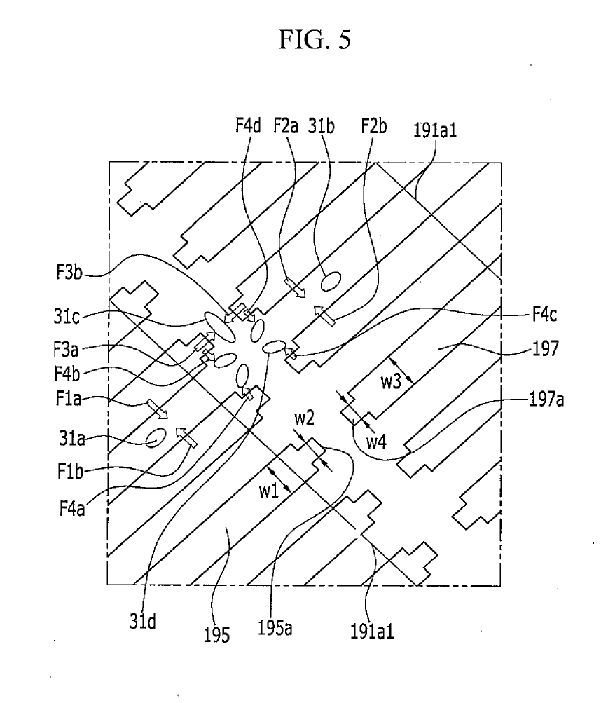

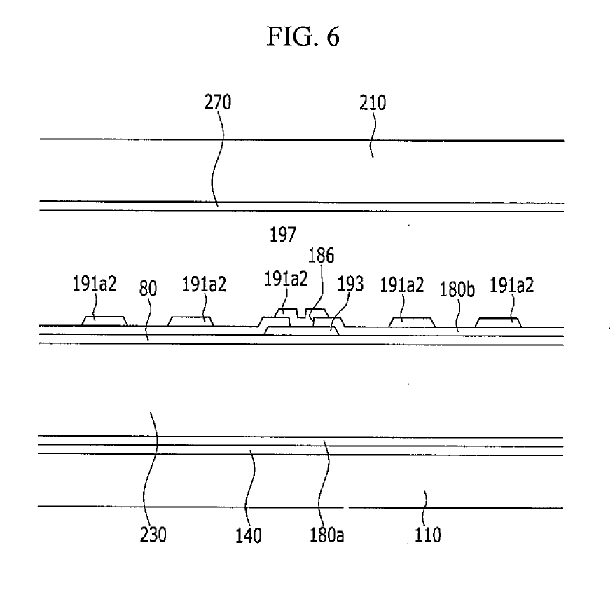

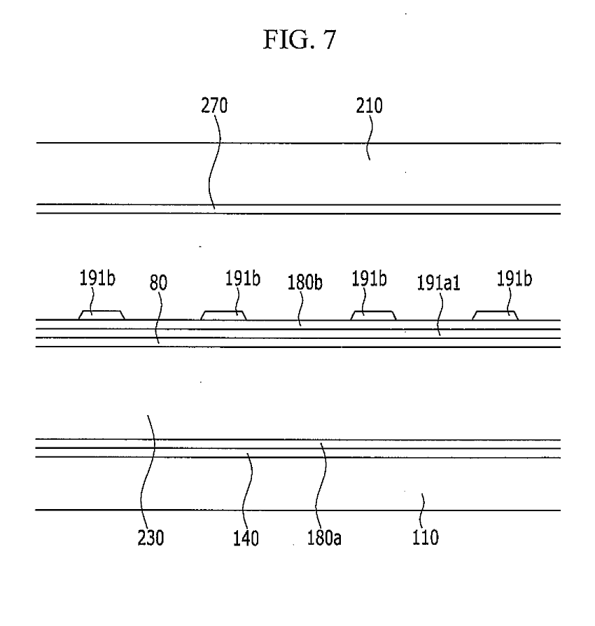

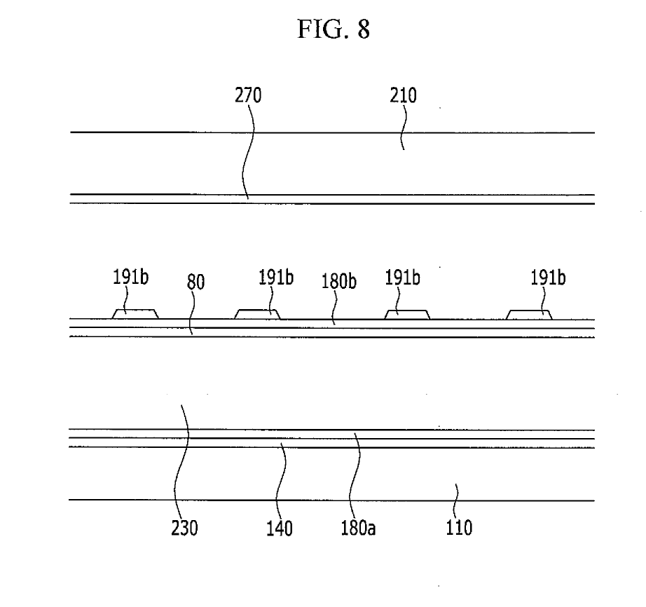

Now, a liquid crystal display, according to an example embodiment of the present invention, will be described with reference to FIG. 1 to FIG. 8. FIG. 1 is a layout view of a liquid crystal display, according to an example embodiment of the present invention. FIG. 2 is a cross-sectional view of the liquid crystal display of FIG. 1 taken along the line II-II. FIG. 3 is a layout view of a first portion of a first subpixel electrode of the liquid crystal display of FIG. 1. FIG. 4 is a layout view of a second portion of a first subpixel electrode of the liquid crystal display of FIG. 1 and a second subpixel electrode. FIG. 5 is a view of a portion of the liquid crystal display of FIG. 1. FIG. 6 is a cross-sectional view of the liquid crystal display of FIG. 1 taken along the line VI-VI. FIG. 7 is a cross-sectional view of the liquid crystal display of FIG. 1 taken along the line VII-VII. FIG. 8 is a cross-sectional view of the liquid crystal display of FIG. 1 taken along the line VIII-VIII.

Referring to FIG. 1 and FIG. 2, the liquid crystal display, according to the example embodiment of the present invention, includes a lower panel 100 and an upper panel 200 facing each other, and a liquid crystal layer 3 interposed between the two display panels 100 and 200.

First, the lower panel 100 will be described.

A gate line 121, a reference voltage line 131, and a storage electrode 135 are formed on a first insulating substrate 110, which is made of transparent glass, plastic, or the like. The gate line 121 mainly extends in a horizontal direction and transfers a gate signal.

The gate line 121 includes a wide end for connection with a first gate electrode 124a, a second gate electrode 124b, a third gate electrode 124c, and another layer or an external driving circuit.

The reference voltage line 131 may extend in parallel with the gate line 121, and has an extension 136, which is coupled to (e.g., connected to) a third drain electrode 175c to be described below.

The reference voltage line 131 includes the storage electrode 135, which encloses a pixel area.

A gate insulating layer 140 is formed on the gate line 121, the reference voltage line 131, and the storage electrode 135.

A first semiconductor 154a, a second semiconductor 154b, and a third semiconductor 154c (which may be made of amorphous silicon, crystalline silicon, and/or the like) are formed on the gate insulating layer 140.

A plurality of ohmic contacts 163a, 163b, 163c, 165a, 165b, and 165b are formed on the first, second, and third semiconductors 154a, 154b, and 154c. When the semiconductors 154a, 154b, and 154c are oxide semiconductors, the ohmic contacts may be omitted.

Data conductors 171, 173a, 173b, 173c, 175a, 175b, and 175c, which include a first source electrode 173a, a second source electrode 173b, a first drain electrode 175a, a second drain electrode 175b, a third source electrode 173c, and a third drain electrode 175c, are formed on the ohmic contacts 163a, 163b, 163c, 165a, and 165b and the gate insulating layer 140.

The second drain electrode 175b is coupled to the third source electrode 173c.

The first gate electrode 124a, the first source electrode 173a, and the first drain electrode 175a form a first thin film transistor Qa along with the first semiconductor 154a, and a channel of the thin film transistor is formed on a portion of the semiconductor 154a between the first source electrode 173a and the first drain electrode 175a. Similarly, the second gate electrode 124b, the second source electrode 173b, and the second drain electrode 175b form a second thin film transistor Qb along with the second semiconductor 154b, and a channel of the thin film transistor is formed on a portion of the semiconductor 154b between the second source electrode 173b and the second drain electrode 175b. The third gate electrode 124c, the third source electrode 173c, and the third drain electrode 175c form a third thin film transistor Qc along with the third semiconductor 154c, and a channel of the thin film transistor is formed on a portion of the semiconductor 154c between the third source electrode 173c and the third drain electrode 175c.

A first passivation layer 180a (which may be made of an insulating material such as a silicon nitride or a silicon oxide) is formed on the data conductors 171, 173a, 173b, 173c, 175a, 175b, and 175c, and exposed portions of the semiconductors 154a, 154b, and 154c.

A color filter 230 is formed on the first passivation layer 180a.

A light blocking member 220 may be disposed on an area in which the color filter 230 is not disposed and a portion of the color filter 230. The light blocking member 220 is referred to as a black matrix, and prevents light from leaking (e.g., protects from light leakage).

A capping layer 80 is disposed on the color filter 230. The capping layer 80 prevents or protects the color filter 230 from lifting, and suppresses the liquid crystal layer 3 from being polluted due to an organic material such as a solvent inflowing from the color filter, thereby reducing (e.g., preventing) defects such as an afterimage, which may occur at the time of driving the screen, from occurring.

A first subregion 191a1 of a first subpixel electrode 191a is disposed on the capping layer 80.

Referring to FIG. 3, the first subregion 191a1 of the first subpixel electrode 191a has a plane shape, which includes a horizontal connection part 192 disposed at a central portion of the pixel area, and four parallelograms disposed around the horizontal connection part 192 to enclose the horizontal connection part 192. Also, the first subregion 191a1 includes an expansion 193 extending in the vertical direction from the center transverse part of the pixel area. In this form, the first subregion 191a1 of the first subpixel electrode 191a is disposed at the portion of the pixel area.

A second passivation layer 180b is disposed on the capping layer 80 and the first subregion 191a1 of the first subpixel electrode 191a.

A second subregion 191a2 of the first subpixel electrode 191a and a second subpixel electrode 191b are disposed on the second passivation layer 180b.

Referring to FIG. 4, the second subregion 191a2 of the first subpixel electrode 191a is disposed at the central portion of the pixel, and the overall shape thereof is rhomboidal. The second subregion 191a2 of the first subpixel electrode 191a includes a cross stem 194 including a transverse part and a longitudinal part, and a plurality of first branch electrodes 195 extending from the cross stem 194. The first branch electrodes 194 extend in four different directions.

The second subpixel electrode 191b includes an outer stem 196 disposed at the edge of the pixel area, and a plurality of second branch electrodes 197 extending from the outer stem 196.

A plurality of first branch electrodes 195 and a plurality of second branch electrodes 197 face each other and extend parallel to each other. A first end 195a of the plurality of first branch electrodes 195 and a second end 197a of the plurality of second branch electrodes 197 facing each other are reduced in width. That is, the plurality of first branch electrodes 195 and the plurality of second branch electrodes 197 have a reduced width (e.g., minimum width) at the first end 195a and the second end 197a.

The second subpixel electrode 191b includes a third subregion overlapping the first subregion 191a1 of the first subpixel electrode 191a and a fourth subregion. The third subregion of the second subpixel electrode 191b faces the first subregion 191a1 of the first subpixel electrode 191a via an insulating layer (e.g., the second passivation layer 180b) interposed (e.g., laterally interposed) therebetween.

The first passivation layer 180a, the capping layer 80, and the second passivation layer 180b are provided with a first contact opening (e.g., contact hole) 185a, which exposes a portion of the first drain electrode 175a. The second passivation layer 180b is provided with a second contact opening 185b, which exposes a portion of the second drain electrode 175b, and the third contact opening 185a, which exposes a portion of the third source electrode 173c. Further, the second passivation layer 180b is provided with a third contact opening 186, which exposes a central portion of the first subregion 191a1 of the first subpixel electrode 191a.

The first subregion 191a1 of the first subpixel electrode 191a is physically and electrically coupled to the first drain electrode 175a through the first contact opening 185a, and the second subpixel electrode 191b is physically and electrically coupled to the second drain electrode 175b through the second contact opening 185b. Further, the second subregion 191a2 of the first subpixel electrode 191a is coupled to the expansion 193 of the first subregion 191a1 of the first subpixel electrode 191a through the third contact opening 186, which is disposed on the second passivation layer 180b.

The first subpixel electrode 191a and the second subpixel electrode 191b are applied with a data voltage from each of the first drain electrode 175a and the second drain electrode 175b through the first contact opening 185a and the second contact opening 185b.

Next, the upper panel 200 will be described.

The light blocking member 220 and a common electrode 270 are formed on a second insulating substrate 210 made of transparent glass, plastic, and/or the like.

However, in the example of a liquid crystal display according to another example embodiment of the present invention, the light blocking member 220 may be disposed on the lower panel 100, and in the example of a liquid crystal display according to another example embodiment of the present invention, the color filter may be disposed on the upper panel 200.

The interiors (e.g., insides) of the display panels 100 and 200 are respectively provided with an alignment layer, which may be a vertical alignment layer.

Polarizers are disposed on outer surfaces of the two display panels 100 and 200, and transmission axes of the two polarizers are orthogonal to each other. In one embodiment, one of the transmission axes is parallel with the gate line 121. However, the polarizers may also be disposed only on the outer surface of either one of the two display panels 100 and 200.

The liquid crystal layer 3 has negative dielectric anisotropy, and liquid crystal molecules of the liquid crystal layer 3 are oriented so that major axes thereof are aligned substantially perpendicularly (or normal) to the surfaces of the two display panels 100 and 200 in the state in which no electric field is present. Therefore, the incident light does not pass through the orthogonal polarizers and is blocked in the state in which no electric field is present.

At least one of the liquid crystal layer 3 and the alignment layer may include a photo-reactive material, and in more detail, a reactive mesogen.

Next, a driving method of the liquid crystal display, according to the example embodiment of the present invention, will be briefly described.

When the gate line 121 is applied with a gate-ON signal, the first gate electrode 124a, the second gate electrode 124b, and the third gate electrode 124c are applied with the gate-ON signal, such that the first switching element Qa, the second switching element Qb, and the third switching element Qc are turned ON. Therefore, a data voltage applied to the data line 171 is applied to the first subpixel electrode 191a and the second subpixel electrode 191b through the first and second switching elements Qa and Qb, which are turned ON. In this example, the first subpixel electrode 191a and the second subpixel electrode 191b are applied with a voltage having substantially the same magnitude. However, the voltage applied to the second subpixel electrode 191b is divided by the third switching element Qc, which is coupled to the second switching element Qb in series. Therefore, the voltage applied to the second subpixel electrode 191b becomes smaller than the voltage applied to the first subpixel electrode 191a.

Referring again to FIG. 1, one pixel area of the liquid crystal display, according to the example embodiment of the present invention, includes a first region R1 in which a portion of the first subregion 191a1 of the first subpixel electrode 191a and the first subpixel electrode 191a are disposed, a second region R2 in which a portion of the first subregion 191a1 of the first subpixel electrode 191a and a portion of the second subpixel electrode 191b are disposed, and a third region R3 in which a portion of the second subpixel electrode 191b is disposed.

The first region R1, the second region R2, and the third region R3 each include four regions along a direction in which a plurality of first branch electrodes 195 and a plurality of second branch electrodes 197 extend.

An area of the second region R2 may be about two times the area of the first region R1, and the area of the third region R3 may be about two times the area of the second region R2. However, an area ratio of the first region R1, the second region R2, and the third region R3 may be suitably changed.

Next, a shape of the branch electrode of the liquid crystal display, according to an example embodiment of the present invention, will be described with reference to FIG. 5.

Referring to FIG. 5, the plurality of first branch electrodes 195 have a reduced width (e.g., minimum width) at the first end 195a adjacent to the second region R2 where the first subregion 191a1 of the first subpixel electrode 191a and the third subregion of the second subpixel electrode 191b overlap. In more detail, the first width w1, as the great width (e.g., the maximum width) of the plurality of first branch electrodes 195, is greater than the second width w2 of the first end 195a, as the reduced width (e.g., minimum width) of the plurality of first branch electrodes 195. In one embodiment, a difference between the first width w1 as the great width (e.g., the maximum width) of the plurality of first branch electrodes 195 and the second width w2 of the first end 195a as the reduced width (e.g., minimum width) of the plurality of first branch electrodes 195 is more than about 0.4 μm.

Similarly, the plurality of second branch electrodes 197 of the second subpixel electrode 191b disposed at the second region R2 have the reduced width (e.g., minimum width) at the second end 197a. In more detail, the third width w3 as the great width (e.g., the maximum width) of the plurality of second branch electrodes 197 is greater than the fourth width w4 of the second end 197a as the reduced width (e.g., minimum width) of the plurality of second branch electrodes 197. In one embodiment, the difference between the third width w3 as the great width (e.g., the maximum width) of the plurality of second branch electrodes 197 and the fourth width w4 of the second end 197a as the reduced width (e.g., minimum width) of the plurality of second branch electrodes 197 is more than about 0.4 μm.

Also, among the plurality of first branch electrodes 195 and the plurality of second branch electrodes 197, the first end 195a of the plurality of first branch electrodes 195 and the second end 197a of the plurality of second branch electrodes 197 overlap the first subregion 191a1 of the first subpixel electrode 191a.

The plurality of first branch electrodes 195 generate the first fringe fields F1a and F1b in a direction substantially perpendicular to the edge of the first branch electrodes 195. Because a gap (e.g., an interval) between two adjacent first branch electrodes 195 is narrow, the liquid crystal molecules (such as the first liquid crystal molecule 31a) are inclined parallel to the length direction of the first branch electrodes 195 and the direction of the first fringe fields F1a and F1b generated at the edge of two adjacent first branch electrodes 195, and then collide. Similarly, the second branch electrodes 197 generate the second fringe fields F2a and F2b in the direction substantially perpendicular to the edge of the second branch electrodes 197. Because a gap (e.g., an interval between) two adjacent second branch electrodes 197 is narrow, the liquid crystal molecules (such as the second liquid crystal molecule 31b) are inclined parallel to the length direction of the second branch electrodes 197 and the direction of the second fringe fields F2a and F2b generated at the edge of two adjacent second branch electrodes 197, and then collide.

In general, third liquid crystal molecules 31c corresponding to (e.g., in or occupying) the region between the first branch electrodes 195 and the second branch electrodes 197 are inclined in the direction substantially perpendicular to the length direction of the first branch electrodes 195 and the second branch electrodes 197 due to the third fringe fields F3a and F3b generated at the ends of the first branch electrodes 195 and the second branch electrodes 197. However, according to an example embodiment of the present invention, the widths of the first ends 195a and the second ends 197a of the first branch electrodes 195 and the second branch electrodes 197 are reduced. Accordingly, the magnitude of the third fringe fields F3a and F3b generated in the direction substantially perpendicular to the edge of the first end 195a and the second end 197a is decreased and the influence of fourth fringe fields F4a, F4b, F4c, and F4d formed by the edge near the first end 195a and the second end 197a is affected. Therefore, fourth liquid crystal molecules 31d are not inclined in the direction perpendicular to the length direction of the first branch electrodes 195 and the second branch electrodes 197, rather, they are inclined in the direction similar to those of the first liquid crystal molecule 31a and the second liquid crystal molecule 31b disposed near the first branch electrodes 195 and the second branch electrodes 197.

Therefore, the display quality deterioration, such as a texture that may be generated between the first branch electrodes 195 and the second branch electrodes 197, may be reduced (e.g., prevented), thereby reducing (e.g., preventing) the transmittance deterioration of the liquid crystal display.

Next, the first region R1, the second region R2, and the third region R3 included in one pixel area of the liquid crystal display, according to the present example embodiment, will be described with reference to FIG. 6 to FIG. 8.

Referring to FIG. 6, in the first region R1 of one pixel area of the liquid crystal display, according to the present example embodiment, the second subregion 191a2 of the first subpixel electrode 191a formed at the lower panel 100 and coupled to the expansion 193 of the first subregion 191a1 of the first subpixel electrode 191a and the common electrode 270 disposed at the upper panel 200 generate the electric field. At this time, the second subregion 191a2 of the first subpixel electrode 191a includes the cross stem and a plurality of first branch electrodes 195 extending in four different direction from the cross stem. A plurality of first branch electrodes 195 may be inclined by about 40 degrees to about 45 degrees with reference to the gate line 121. By the fringe field generated by the edge of a plurality of first branch electrodes 195, the liquid crystal molecules of the liquid crystal layer 3 corresponding to the first region R1 are inclined in four different directions. In more detail, the liquid crystal molecules are inclined in the direction parallel to the length direction of a plurality of first branch electrodes 195.

Referring to FIG. 7, in the second region R2 of one pixel area of the liquid crystal display, according to the present example embodiment, the third subregion of the second subpixel electrode 191b disposed at the lower panel 100 and the first subregion 191a1 of the first subpixel electrode 191a overlap each other. Along with the electric field formed between the third subregion of the second subpixel electrode 191b and the common electrode 270 of the upper panel 200, by the electric field formed between the first subregion 191a1 of the first subpixel electrode 191a disposed between a plurality of second branch electrodes 197 of the third subregion of the second subpixel electrode 191b and the common electrode 270 and the electric field formed between the third subregion of the second subpixel electrode 191b and the first subregion 191a1 of the first subpixel electrode 191a, the liquid crystal molecules of the liquid crystal layer 3 are arranged. In this example, the liquid crystal molecules are inclined in the direction parallel to the length direction of a plurality of second branch electrodes 197.

Next, referring to FIG. 8, in the third region R3 of one pixel area of the liquid crystal display, according to the present example embodiment, the fourth subregion of the second subpixel electrode 191b disposed at the lower panel 100 and the common electrode 270 of the upper panel 200 generate the electric field. In this example, the fourth subregion of the second subpixel electrode 191b includes a plurality of second branch electrodes 197. Accordingly, the liquid crystal molecules are inclined in the direction parallel to the length direction of a plurality of second branch electrodes 197.

As described above, the magnitude of the second voltage applied to the second subpixel electrode 191b is smaller than the first voltage applied to the first subpixel electrode 191a.

Accordingly, the intensity of the electric field applied to the liquid crystal layer disposed at the first region R1 is largest and the intensity of the electric field applied to the liquid crystal layer disposed at the third region R3 is smallest. In the second region R2, because the influence of the electric field of the first subpixel electrode 191a disposed under the second subpixel electrode 191b exists, the intensity of the electric field applied to the liquid crystal layer disposed at the second region R2 is smaller than the intensity of the electric field applied to the liquid crystal layer disposed at the first region R1, and is larger than the intensity of the electric field applied to the liquid crystal layer disposed at the third region R3.

As described above, in the liquid crystal display, according to an example embodiment of the present invention, one pixel area is divided into the first region disposed with the first subpixel electrode applied with the first voltage that is relatively high, the second region where the portion of the first subpixel electrode and the portion of the second subpixel electrode applied with the second voltage that is relatively low are overlapped with each other via the insulating layer interposed therebetween, and the third region where the second subpixel electrode applied with the second voltage that is relatively low is disposed. Accordingly, because the intensities of the electric fields applied to the liquid crystal molecules corresponding to the first region, the second region, and the third region are different, the inclination angles of the liquid crystal molecules are different, thereby differentiating the luminance of each region. As described above, when one pixel area is divided into three regions having the different luminances, by smoothly controlling the change of the transmittance according to the gray level, the transmittance according to the gray level change may be prevented from being sharply changed in the high gray level as well as the low gray level, thereby correctly expressing the gray in the low gray level and the high gray level while side visibility is close to (is matched to) front visibility.

Also, as described above, according to an example embodiment of the present invention, the first branch electrodes 195 and the second branch electrodes 197 have the reduced width (e.g., minimum width) at the first end 195a and the second end 197a facing each other. Accordingly, the influence of the fringe field generated in the direction substantially perpendicular to the edge of the first end 195a and the second end 197a is decreased and the influence of the fringe field formed by the edges near the first end 195a and the second end 197a is generated such that the liquid crystal molecules disposed between the first branch electrodes 195 and the second branch electrodes 197 are not inclined in the direction perpendicular to the length direction of the first branch electrodes 195 and the second branch electrodes 197, but are inclined in the direction parallel to the length direction of the first branch electrodes 195 and the second branch electrodes 197, similar to the liquid crystal molecules disposed near the first branch electrodes 195 and the second branch electrodes 197.

Therefore, the display quality deterioration generated between the first branch electrodes 195 and the second branch electrodes 197 such as the texture may be reduced (e.g., prevented), thereby reducing (e.g., preventing) the transmittance deterioration of the liquid crystal display.

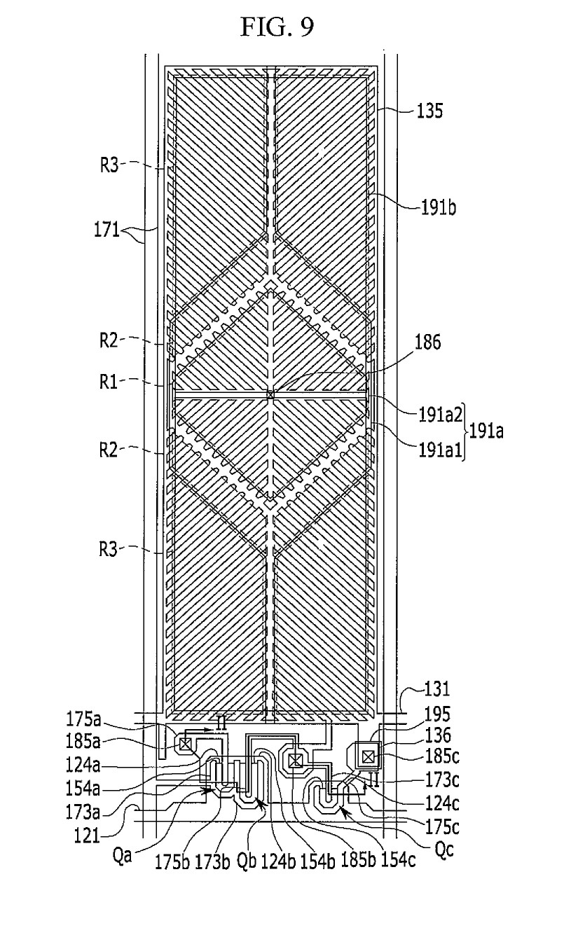

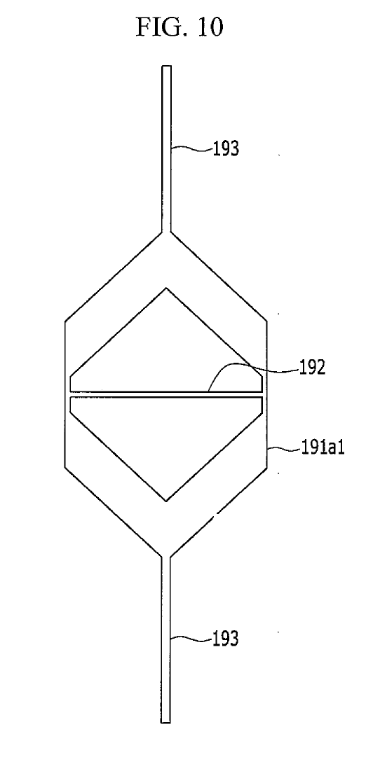

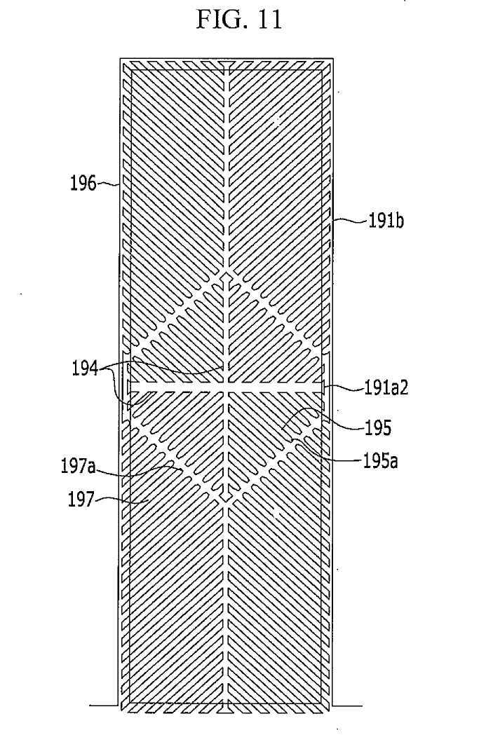

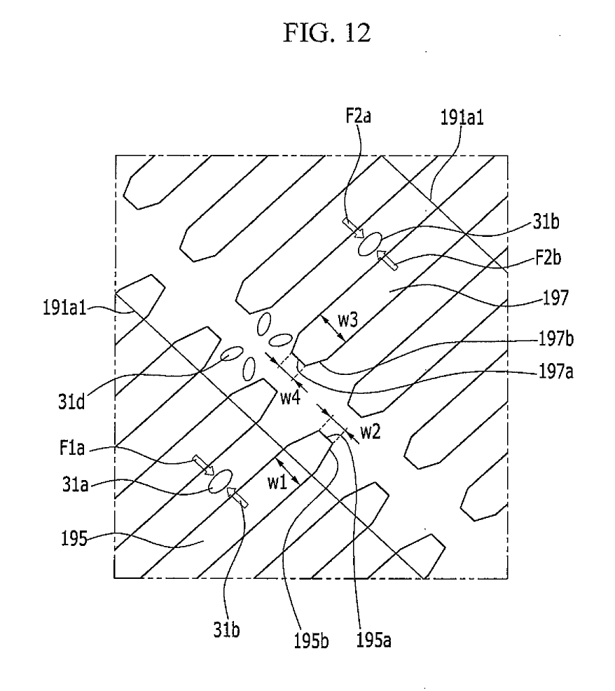

Next, the liquid crystal display, according to another example embodiment of the present invention, will be described with reference to FIG. 9 to FIG. 12. FIG. 9 is a layout view of a liquid crystal display, according to another example embodiment of the present invention. FIG. 10 is a layout view of a first portion of a first subpixel electrode of the liquid crystal display of FIG. 9. FIG. 11 is a layout view of a second portion of a first subpixel electrode of the liquid crystal display of FIG. 9 and a second subpixel electrode. FIG. 12 is a view of a portion of the liquid crystal display of FIG. 9.

Referring to FIG. 9, the liquid crystal display, according to the present example embodiment, is substantially the same as the liquid crystal display, according to the example embodiment shown in FIG. 1 and FIG. 2. Therefore, a description of overlapping constituent elements may not be provided.

Referring to FIG. 1 to FIG. 8, similar to the liquid crystal display according to the described example embodiment, one pixel area of the liquid crystal display, according to the present example embodiment, includes the first region R1 where the second subregion 191a2 of the first subpixel electrode 191a is disposed, the second region R2 where the first subregion 191a1 of the first subpixel electrode 191a and the third subregion of the second subpixel electrode 191b are overlapped with each other, and the third region R3 where the fourth subregion of the second subpixel electrode 191b is disposed.

The first region R1, the second region R2, and the third region R3 are respectively divided into four subregions by the extending directions of a plurality of first branch electrodes 195 and a plurality of second branch electrodes 197.

In the first region R1 of one pixel area of the liquid crystal display, according to the present example embodiment, the second subregion 191a2 of the first subpixel electrode 191a disposed at the lower panel 100 and coupled to the expansion 193 of the first subregion 191a1 of the first subpixel electrode 191a and the common electrode 270 disposed at the upper panel 200 generate the electric field. In the second region R2 of one pixel area of the liquid crystal display, according to the present example embodiment, the third subregion of the second subpixel electrode 191b disposed at the lower panel 100 and the first subregion 191a1 of the first subpixel electrode 191a are overlapped with each other. Along with the electric field formed between the third subregion of the second subpixel electrode 191b and the common electrode 270 of the upper panel 200, by the electric field formed between the first subregion 191a1 of the first subpixel electrode 191a disposed between a plurality of second branch electrodes 197 of the third subregion of the second subpixel electrode 191b and the common electrode 270, and the electric field formed between the third subregion of the second subpixel electrode 191b and the first subregion 191a1 of the first subpixel electrode 191a, the liquid crystal molecules of the liquid crystal layer 3 are arranged. In the third region R3 of one pixel area of the liquid crystal display, according to the present example embodiment, the fourth subregion of the second subpixel electrode 191b disposed at the lower panel 100 and the common electrode 270 disposed at the upper panel 200 together generate the electric field.

The magnitude of the second voltage applied to the second subpixel electrode 191b is smaller than the first voltage applied to the first subpixel electrode 191a.

Accordingly, the intensity of the electric field applied to the liquid crystal layer disposed at the first region R1 is largest and the intensity of the electric field applied to the liquid crystal layer disposed at the third region R3 is smallest. In the second region R2, because the influence of the electric field of the first subpixel electrode 191a disposed under the second subpixel electrode 191b exists, the intensity of the electric field applied to the liquid crystal layer disposed at the second region R2 is smaller than the intensity of the electric field applied to the liquid crystal layer disposed at the first region R1, and is larger than the intensity of the electric field applied to the liquid crystal layer disposed at the third region R3.

As described above, in the liquid crystal display, according to an example embodiment of the present invention, one pixel area is divided into the first region disposed with the first subpixel electrode applied with the first voltage that is relatively high, the second region where the portion of the first subpixel electrode and the portion of the second subpixel electrode applied with the second voltage that is relatively low are overlapped with each other via the insulating layer interposed therebetween, and the third region where the second subpixel electrode applied with the second voltage that is relatively low is disposed. Accordingly, because the intensities of the electric fields applied to the liquid crystal molecules corresponding to the first region, the second region, and the third region are different, the inclination angles of the liquid crystal molecules are different, thereby differentiating the luminance of each region. As described above, when one pixel area is divided into three regions having the different luminances, by smoothly controlling the change of the transmittance according to the gray level, the transmittance according to the gray level change may be prevented or restrained from being sharply changed in the high gray level as well as the low gray level, thereby correctly expressing the gray level in the low gray level and the high gray level while side visibility is close to (is matched to) front visibility.

Referring to FIG. 10, the first subregion 191a1 of the first subpixel electrode 191a has the plane shape including a transverse connection 192 disposed at the center of the pixel area and four parallelograms disposed near and enclosing the transverse connection 192. Also, the first subpixel electrode 191a has the expansion 193 extending up and down from the transverse center portion of the pixel area. As described above, the first subregion 191a1 of the first subpixel electrode 191a is disposed at the portion of the pixel area.

Referring to FIG. 11, the second subregion 191a2 of the first subpixel electrode 191a is disposed at the center portion of the pixel, and the entire shape is rhomboidal. The second subregion 191a2 of the first subpixel electrode 191a has the cross stem 194 including the transverse portion and the longitudinal portion and a plurality of first branch electrodes 195 extending from the cross stem. The first branch electrodes 195 extend in four directions.

The second subpixel electrode 191b includes the outer stem 196 disposed at the edge of the pixel area and a plurality of second branch electrodes 197 extending from the outer stem 196.

A plurality of first branch electrodes 195 and a plurality of second branch electrodes 197 face each other and extend in parallel. The first end 195a of a plurality of first branch electrodes 195 and the second end 197a of a plurality of second branch electrodes 197 have the reduced width (e.g., minimum width).

However, the liquid crystal display, according to the present example embodiment, differently from the example embodiment described with reference to FIG. 1 to FIG. 8, includes an inclination portion between the first end 195a of a plurality of first branch electrodes 195 and a plurality of first branch electrodes 195, and an inclination portion between the second end 197a of a plurality of second branch electrodes 197 and a plurality of second branch electrodes 197.

That is, a plurality of first branch electrodes 195 and a plurality of second branch electrodes 197 have the width that is decreased close to the first end 195a and the second end 197a facing each other, and thereby a plurality of first branch electrodes 195 and a plurality of second branch electrodes 197 have the shape having the reduced width (e.g., minimum width) at the first end 195a and the second end 197a.

Next, the shape of the branch electrode of the liquid crystal display, according to an example embodiment of the present invention, will be described with reference to FIG. 12.

Referring to FIG. 12, the width of a plurality of first branch electrodes 195 is decreased close to the first end 195a of the plurality of first branch electrodes 195 of the first subpixel electrode 191a adjacent to the second region R2, thereby having the reduced width (e.g., minimum width) at the first end 195a. Accordingly, a first inclination portion 195b is included in the first end 195a of a plurality of first branch electrodes 195 and a plurality of first branch electrodes 195.

The first width w1 as the great width (e.g., the maximum width) of a plurality of first branch electrodes 195 is greater than the second width w2 of the first end 195a as the reduced width (e.g., minimum width) of a plurality of first branch electrodes 195. The ratio of the second width w2 of the first end 195a as the reduced width (e.g., minimum width) of a plurality of first branch electrodes 195 to the first width w1 as the great width (e.g., the maximum width) of a plurality of first branch electrodes 195 is, in one embodiment, less than about 0.86.

Similarly, the width of a plurality of second branch electrodes 197 of the second subpixel electrode 191b disposed at the second region R2 is decreased close to the second end 197a of a plurality of second branch electrodes 197 of the second subpixel electrode 191b, thereby having the shape with the reduced width (e.g., minimum width) at the second end 197a. Accordingly, a second inclination portion 197b is included between the second end 197a of a plurality of second branch electrodes 197 and the plurality of second branch electrodes 197. The ratio of the fourth width w4 of the second end 197a as the reduced width (e.g., minimum width) of a plurality of second branch electrodes 197 to the third width w3 as the great width (e.g., the maximum width) of a plurality of second branch electrodes 197 is, in one embodiment, less than about 0.86.

Also, among a plurality of first branch electrodes 195 and a plurality of second branch electrodes 197, the first end 195a and the first inclination portion 195b of the plurality of first branch electrodes 195, and the second end 197a and the second inclination portion 197b of the plurality of second branch electrodes 197, overlap the first subregion 191a1 of the first subpixel electrode 191a.

The plurality of first branch electrodes 195 generate the first fringe fields F1a and F1b in the direction substantially perpendicular to the edge of the first branch electrodes 195. Because a gap (e.g., an interval) between two adjacent first branch electrodes 195 is narrow, the liquid crystal molecules (such as the first liquid crystal molecule 31a) are inclined parallel to the length direction of the first branch electrodes 195 and the direction of the first fringe fields F1a and F1b generated at the edge of the two adjacent first branch electrodes 195 and then collide.

Similarly, the second branch electrodes 197 generate second fringe fields F2a and F2b in the direction substantially perpendicular to (e.g., vertical to) the edge of the second branch electrodes 197. Because a gap (e.g., an interval) between two adjacent second branch electrodes 197 is narrow, the liquid crystal molecules (such as the second liquid crystal molecule 31b) are inclined parallel to the length direction of the second branch electrodes 197 and the direction of the second fringe fields F2a and F2b generated at the edge of two adjacent second branch electrodes 197 and then collide.

In general, the liquid crystal molecules corresponding to the region between the first branch electrodes 195 and the second branch electrodes 197 are inclined in the direction substantially perpendicular to the length direction of the first branch electrodes 195 and the second branch electrodes 197 by the fringe fields generated at the end of the first branch electrodes 195 and the second branch electrodes 197. However, according to an example embodiment of the present invention, the widths of the first end 195a and the second end 197a of the first branch electrodes 195 and the second branch electrodes 197 are reduced. Accordingly, the magnitude of the fringe fields generated in the direction substantially perpendicular to the edge of the first end 195a and the second end 197a is decreased and the influence of the fringe fields formed by the edge near the first end 195a and the second end 197a is affected, thereby the liquid crystal molecules are not inclined in the direction perpendicular to the length direction of the first branch electrodes 195 and the second branch electrodes 197, but are inclined in the direction similar to those of the first liquid crystal molecule 31a and the second liquid crystal molecule 31b disposed near the first branch electrodes 195 and the second branch electrodes 197.

Therefore, the display quality deterioration such as a texture that may be generated between the first branch electrodes 195 and the second branch electrodes 197 may be reduced (e.g., prevented), thereby reducing (e.g., preventing) the transmittance deterioration of the liquid crystal display.

As described above, in the liquid crystal display, according to an example embodiment of the present invention, one pixel area is divided into the first region disposed with the first subpixel electrode applied with the first voltage that is relatively high; the second region where the portion of the first subpixel electrode and the portion of the second subpixel electrode applied with the second voltage that is relatively low are overlapped with each other via the insulating layer interposed therebetween; and the third region where the second subpixel electrode applied with the second voltage that is relatively low is disposed. Accordingly, because the intensities of the electric fields applied to the liquid crystal molecules corresponding to the first region, the second region, and the third region are different, the inclination angles of the liquid crystal molecules are different, thereby differentiating the luminances of each region. As described above, when one pixel area is divided into three regions having the different luminances, by smoothly controlling the change of the transmittance according to the gray level, the transmittance according to the gray level change may be prevented or restrained from being sharply changed in the high gray level as well as the low gray level, thereby correctly expressing the gray level in the low gray level and the high gray level while side visibility is close to (is matched to) front visibility. Also, according to an example embodiment of the present invention, the widths of the first end 195a and the second end 197a of the first branch electrodes 195 and the second branch electrodes 197 are decreased. Accordingly, the influence of the fringe field generated in the direction substantially perpendicular to the edge of the first end 195a and the second end 197a is decreased. Further, the influence of the fringe field formed by the edges near the first end 195a and the second end 197a is generated such that the liquid crystal molecules disposed between the first branch electrodes 195 and the second branch electrodes 197 are not inclined in the direction perpendicular to the length direction of the first branch electrodes 195 and the second branch electrodes 197, but are inclined in the direction parallel to the length direction of the first branch electrodes 195 and the second branch electrodes 197, similar to the liquid crystal molecules disposed near the first branch electrodes 195 and the second branch electrodes 197.

Therefore, the display quality deterioration generated between the first branch electrodes 195 and the second branch electrodes 197, such as the texture, may be reduced (e.g., prevented), thereby reducing (e.g., preventing) the transmittance deterioration of the liquid crystal display.

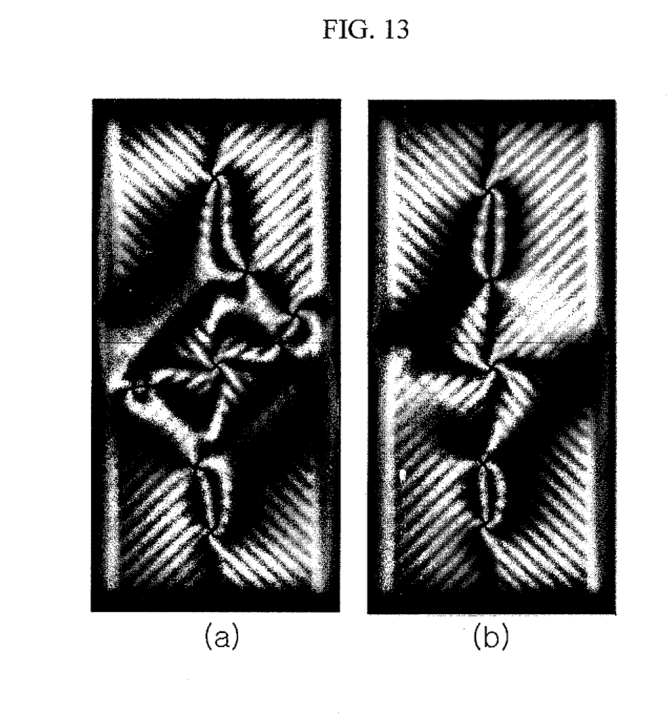

Next, an experimental example of the present invention will be described with reference to FIG. 13. FIG. 13 is an electron microscopic picture of a transmittance result of a liquid crystal display, according to an experimental example of the present invention.

The present experimental examples compare the transmittance of the liquid crystal display when the width of the first branch electrodes 195 and the second branch electrodes 197 facing each other is uniformly formed with when the width of the first branch electrodes 195 and the second branch electrodes 197 are greater than the widths of the first end 195a and the second end 197a, as in the liquid crystal display, according to an example embodiment of the present invention. Except for the shape of the first branch electrodes 195 and the second branch electrodes 197, other conditions are substantially the same.

In FIG. 13, (a) represents the example in which the widths of the first branch electrodes 195 and the second branch electrodes 197 facing each other are uniformly formed, and (b) represents the example in which the widths of the first end 195a of the first branch electrodes 195 and the second end 197a of the second branch electrodes 197 are smaller than the width of the first branch electrodes 195 and the second branch electrodes 197 as in the liquid crystal display according to an example embodiment of the present invention.

Referring to FIG. 13, according to an example embodiment of the present invention, compared with the related art liquid crystal display, it may be confirmed that the transmittance deterioration generated at the portion disposed between the first branch electrodes 195 and the second branch electrodes 197 is decreased.

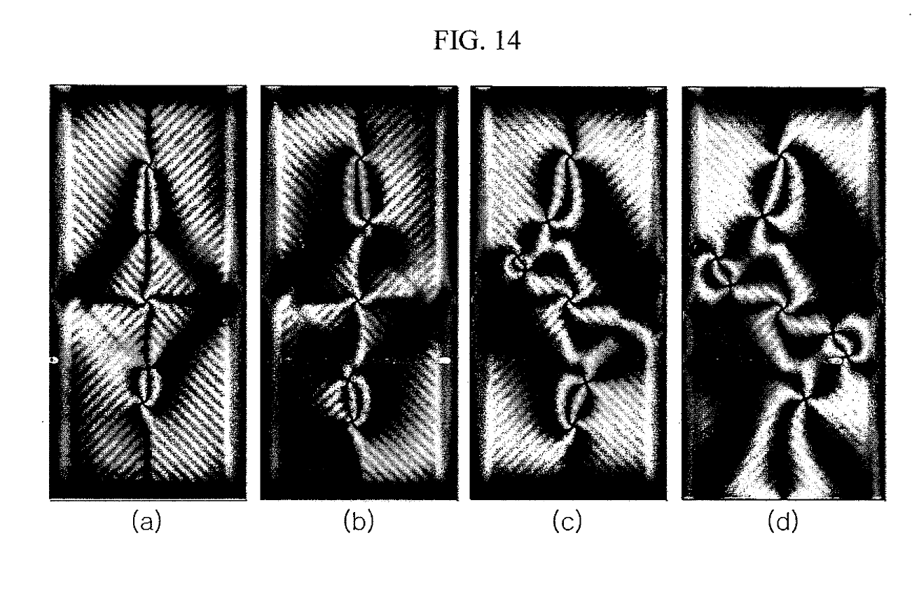

Next, another experimental example of the present invention will be described with reference to FIG. 14. FIG. 14 is an electron microscopic picture of a transmittance result of a liquid crystal display, according to another experimental example of the present invention.

The present experimental examples compare the transmittance of the liquid crystal display as the width of the first end 195a and the second end 197a change relative to the widths of the first branch electrodes 195 and the second branch electrodes 197. Except for the shape of the first branch electrodes 195 and the second branch electrodes 197, other conditions are substantially the same.

In FIG. 14, (a) represents the example in which the ratio of the widths of the first end 195a of the first branch electrodes 195 and the second end 197a of the second branch electrodes 197 to the widths of the first branch electrodes 195 and the second branch electrodes 197 is about 0.8, (b) represents the example in which the ratio of the widths of the first end 195a of the first branch electrodes 195 and the second end 197a of the second branch electrodes 197 to the widths of the first branch electrodes 195 and the second branch electrodes 197 is about 0.86, (c) represents the example in which the ratio of the widths of the first end 195a of the first branch electrodes 195 and the second end 197a of the second branch electrodes 197 to the widths of the first branch electrodes 195 and the second branch electrodes 197 is about 0.93, and (d) represents the example in which the widths of the first branch electrodes 195 and the second branch electrodes 197 is constant.

Referring to FIG. 14, in the examples of (a) and (b), compared with (c) and (d), it may be confirmed that the transmittance deterioration generated at the portion disposed between the first branch electrodes 195 and the second branch electrodes 197 is decreased. That is, compared with the related art liquid crystal display, according to an example embodiment of the present invention, it may be confirmed that the transmittance deterioration generated at the portion disposed between the first branch electrodes 195 and the second branch electrodes 197 is decreased, and particularly, in the example in which the ratio of the widths of the first end 195a of the first branch electrodes 195 and the second end 197a of the second branch electrodes 197 to the widths of the first branch electrodes 195 and the second branch electrodes 197 is less than about 0.86, it may be confirmed that the transmittance deterioration generated at the portion disposed between the first branch electrodes 195 and the second branch electrodes 197 is further decreased.

While this invention has been described in connection with what is presently considered to be practical example embodiments, it is to be understood that the invention is not limited to the disclosed embodiments, but, on the contrary, is intended to cover various suitable modifications and equivalent arrangements included within the spirit and scope of the appended claims, and equivalents thereof.

What is claimed is:

1. A liquid crystal display comprising:
a first substrate;
a first subpixel electrode on the first substrate and including a first subregion and a second subregion, the first subpixel electrode being configured to receive a first voltage;
a second subpixel electrode on the first substrate and including a third subregion and a fourth subregion, the second subpixel electrode being configured to receive a second voltage;
an insulating layer between the first subpixel electrode and the second subpixel electrode;
a second substrate facing the first substrate; and
a common electrode at the second substrate and configured to receive a common voltage,
wherein the third subregion overlaps the first subregion,
wherein the second subregion comprises a plurality of first branch electrodes,
wherein the second subpixel electrode comprises a plurality of second branch electrodes,
wherein the plurality of first branch electrodes and the plurality of second branch electrodes comprise a first end and a second end facing each other, and
wherein the plurality of second branch electrodes have a reduced width at the second end.

2. The liquid crystal display of claim 1, wherein:
the plurality of first branch electrodes have a reduced width at the first end.

3. The liquid crystal display of claim 2, wherein
the first end and the second end overlap the first subregion.

4. The liquid crystal display of claim 3, wherein
a difference of a great width of the plurality of first branch electrodes and a reduced width of the first end is more than about 0.4 μm, and
a difference of a great width of the plurality of second branch electrodes and a reduced width of the second end is more than about 0.4 μm.

5. The liquid crystal display of claim 4, wherein
the first subregion and the second subregion are coupled through a contact opening formed at the insulating layer.

6. The liquid crystal display of claim 4, wherein
a difference of the first voltage and the common voltage is greater than a difference of the second voltage and the common voltage.

7. The liquid crystal display of claim 3, wherein
a width of the plurality of first branch electrodes is gradually decreased closer to the first end, and
a width of the plurality of second branch electrodes is decreased closer to the second end.

8. The liquid crystal display of claim 7, wherein
a ratio of the reduced width of the first end to the great width of the plurality of first branch electrodes is less than about 0.86, and
a ratio of the reduced width of the second end to the great width of the plurality of second branch electrodes is less than about 0.86.

9. The liquid crystal display of claim 8, wherein
the first subregion and the second subregion are coupled through a contact opening at the insulating layer.

10. The liquid crystal display of claim 8, wherein
a difference of the first voltage and the common voltage is greater than a difference of the second voltage and the common voltage.

11. The liquid crystal display of claim 1, wherein
the second end overlaps the first subregion.

12. The liquid crystal display of claim 11, wherein
a difference of a great width of the plurality of second branch electrodes and the reduced width of the second end is more than about 0.4 μm.

13. The liquid crystal display of claim 12, wherein
the first subregion and the second subregion are coupled through a contact opening formed at the insulating layer.

14. The liquid crystal display of claim 12, wherein
a difference of the first voltage and the common voltage is greater than a difference of the second voltage and the common voltage.

15. The liquid crystal display of claim 1, wherein
a width of a plurality of second branch electrodes is gradually decreased closer to the second end.

16. The liquid crystal display of claim 15, wherein
a ratio of the reduced width of the second end to the great width of a plurality of second branch electrode is less than about 0.86.

17. The liquid crystal display of claim 16, wherein
the first subregion and the second subregion are coupled through a contact opening formed at the insulating layer.

18. The liquid crystal display of claim 16, wherein
a difference of the first voltage and the common voltage is greater than a difference of the second voltage and the common voltage.
